(19) United States
(12) Patent Application Publication
(10) Pub. No.: US 2019/0368946 A1
(43) Pub. Date: Dec. 5, 2019

(54) Measuring Temperature for Monitoring and Control of a Fiber Web or Finishing Machine

(71) Applicant: Valmet Technologies Oy, Espoo (FI)

(72) Inventors: Tatu Pitkänen, Nummenkylä (FI); Joe Cook, Steens, MS (US); Heikki Kettunen, Espoo (FI); Gregory Vande Corput, Neenah, WI (US)

(73) Assignee: Valmet Technologies Oy, Espoo (FI)

(21) Appl. No.: 16/431,037

(22) Filed: Jun. 4, 2019

(30) Foreign Application Priority Data
Jun. 5, 2018 (FI) 20185515

(51) Int. Cl. G01K 13/08

(52) U.S. Cl. CPC G01K 13/08; B65H 23/188

(57) ABSTRACT

A method for the monitoring and control of the operating conditions of a fiber web machine or paper finishing machine, where the monitoring and control are performed on a rotatable machine element (41) equipped with a sensor assembly (24) that measures temperature, and generates a measurement signal (25), and a cross-directional temperature profile (21) of the machine element is generated from the measurement signal. One or more reference profiles (35) are generated for the cross-directional temperature profile of the machine element. The cross-directional temperature profile of the machine element generated from the measurement signal and at least one reference profile generated for it are compared to find a change concerning the operating conditions of the fiber web machine or paper finishing machine, and actions are performed on the basis of said change. The invention also relates to a corresponding system, a rotating machine element and a computer program product.

### CROSS REFERENCES TO RELATED APPLICATIONS

This application claims priority from Finnish application FI 20185515 filed Jun. 5, 2018, which is incorporated herein by reference.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a method for the monitoring and control of the operating conditions of a fiber web machine or paper finishing machine, where the monitoring and control are performed on a machine element rotatable in the machine, and where the machine element is equipped with a sensor assembly that measures temperature, and wherein
a measurement signal is generated by the sensor assembly from the temperature of the machine element,
a cross-directional profile of the temperature of the machine element is generated from the measurement signal.

Moreover, the invention also relates to a corresponding system, a rotating machine element and a computer program product.

It is known that the internal water circulation of the rolls of fiber web machines often causes significant internal lime accumulations in rolls, and often also other fouling. These result in issues such as vibration problems in rolls. In addition, the accumulations also influence the force profiles of roll nips.

Moreover, the operation of rolls, especially in the case of variable crown rolls and zone rolls, is affected by the temperature profile impacts of the internal oil circulation of a roll. If the oil circulation affects the roll, for example, due to flow disturbances so that some area of the roll (typically one end of the roll) runs hotter than the rest of the roll, this leads to a greater linear load in this particular area of the roll. Such a phenomenon subsequently has an impact on the profile of the paper, and can even cause a roll coating failure.

The operation of rolls is also affected by temperature profile impacts brought about by profiling devices arranged in connection with rolls. Such profiling devices may include infrared dryers, induction/air profiling devices and especially a steam box in the press section. A steam box in the press section has an impact on the profile of the press nip and consequently also on susceptibility to roll coating failure.

The above-mentioned temperature impacts can be seen, for example, in the force profile measured by the applicant's iRoll system. However, these cannot be used for drawing direct conclusions about which phenomenon is the result of the temperature profile and which phenomenon is the result of other factors.

### SUMMARY OF THE INVENTION

The object of the present invention is to provide a method, a system, a rotating machine element and a computer program product, which can be used for improving the monitoring and control of the operating conditions of a fiber web machine or paper finishing machine. The method according to the invention involves generating one or more cross-directional temperature reference profiles of a machine element, to which a particular cross-directional temperature profile is compared to find a change concerning the operating conditions of the fiber web machine or paper finishing machine. Performing actions on the basis of said change.

For example the phenomena mentioned in connection with the description of prior art can be detected and corrected better by means of a temperature sensor assembly installed on a roll as a result of the invention, by means of temperature profile measurement carried out by the sensor assembly and by comparing the temperature profile generated on the basis of the measurement to a known and proven temperature profile. The profiles can be compared, for example, by means of computer applications run in the control system of the machine. They may also be used for suggesting corrective actions on the basis of issues such as the profile in which a deviation occurs and on the basis of the type of the deviation.

The temperature profile monitoring carried out on the shell and/or coating of a roll can be used for drawing conclusions about issues such as the need for the maintenance and cleaning of the roll, the functioning of the circulation and/or supply of oil or other medium in the roll and any disturbances in these, and/or the impacts of profiling devices on the roll and the production process. Generally speaking, the invention gives better information on the factors that result from temperature, and it is also possible to define and allocate the corrective actions better and to more effective locations in the process than with prior art.

According to an embodiment, the measurement of the nip force profile and/or its potential comparison to a nip force profile of a known and proven situation may also be integrated into the measurement and comparison of the temperature profile. It is also possible to search correlations between various profiles. This further facilitates the finding of the problematic issue and the more precise allocation of corrective actions. In this case, when, for example, one of the profiles is acceptable, it excludes at least some of the potential sources of the problem that have no essential impact on the profile in question. Other additional advantages achieved with the method, system and computer program product according to the invention become apparent from the description, and the characteristic features are set forth in the claims.

### BRIEF DESCRIPTION OF THE DRAWINGS

The invention, which is not restricted to the embodiments presented below, is described in more detail by making reference to the enclosed drawings.

FIG. 1 shows a rough diagrammatic view of an example of a fiber web machine and sizer.

FIG. 2a shows a first example of a machine element equipped with a temperature sensor assembly, which machine element can be utilized in the invention.

FIG. 2b shows a second example of a machine element equipped with a temperature sensor assembly, which machine element can be utilized in the invention.

FIG. 3 shows a rough diagrammatic view of the fiber web machine of FIG. 1 and a condition monitoring system included therein.

FIG. 4 shows a general flowchart view of an example of the method according to the invention.

FIG. 5 shows a flowchart view of an example of the method according to the invention for the monitoring and control of the operation of a roll.

FIG. 6 shows a flowchart view of an example of the method according to the invention for the monitoring and control of the operation of a profiling device.

FIG. 7 shows a flowchart view of an example of the method according to the invention for the monitoring and control of the operating conditions of the production process, where temperature measurement and the measurement of the nip force or nip pressure together are utilized.

FIG. 8a shows an example of a nip force profile when the steam box in the press section is out of use.

FIG. 8b shows an example of a nip temperature profile when the steam box in the press section is out of use.

FIG. 9a shows an example of a nip force profile when the steam box in the press section is in use.

FIG. 9b shows an example of a nip temperature profile when the steam box in the press section is in use.

FIG. 10 shows on a level of principle information what is generated from temperature profile measurement data for the monitoring of the operating conditions of a roll.

### DESCRIPTION OF THE PREFERRED EMBODIMENTS

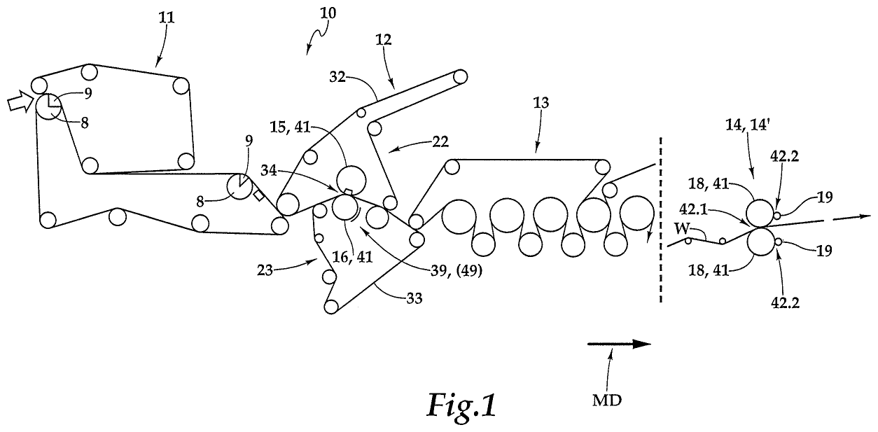

FIG. 1 shows a rough diagrammatic view of an example of an application of the invention, where the application here is a fiber web machine 10. In addition to a fiber web machine 10, the invention can also be utilized, for example, in a paper finishing machine 14, which is also shown in FIG. 1 at the end of the fiber web machine 10 when viewing it in the machine direction MD. Some examples of paper finishing machines 14 include winding, slitting, calendering, coating, surface sizing 14′ and rewinding.

A fiber web machine or paper finishing machine includes one or more sub-entities 11-14. A fiber web machine 10 may include consecutive sub-entities in the direction of travel of the web W, in other words in the machine direction MD (starting from the left edge of FIG. 1): headbox (not shown), web forming section 11, press section 12, dryer section 13, one or more potential paper finishing devices 14, of which a sizer 14′ is presented as an example in FIG. 1. The paper finishing machine can be a fixed part of the machine line (online) or a separate sub-entity of its own (offline). Naturally, there can be other parts, too, between the parts 11-14. In this way, the sequence shown is not intended to limit the invention in any way. After the dryer section 13, there can be for example calendering, coating, sizing 14′ shown in FIG. 1 and/or second drying, which are just some examples that can be mentioned here before the reel (not shown).

At least some of the sub-entities 11-14 of the fiber web machine 10 contain one or more rotatable machine elements 41. Some examples of rotatable machine elements 41 are rolls and cylinders 15, 16, 18 that are in contact with the web W or that otherwise influence the web W indirectly. At least one fabric 32, 33 can be arranged to travel via the rolls and cylinders 15, 16, as is the case, for example, in the sub-entities 11-13. The fabrics 32, 33 circulate in fabric runs 22, 23. A sub-entity 14 may also be without a fabric run. This is the case in the application example of the sizer 14′, in other words the sub-entity 14. In this case, the machine element 18, in other words a roll, is in direct contact with the web W. In some positions, the contact of the web W with the rotating machine element may be on one side only.

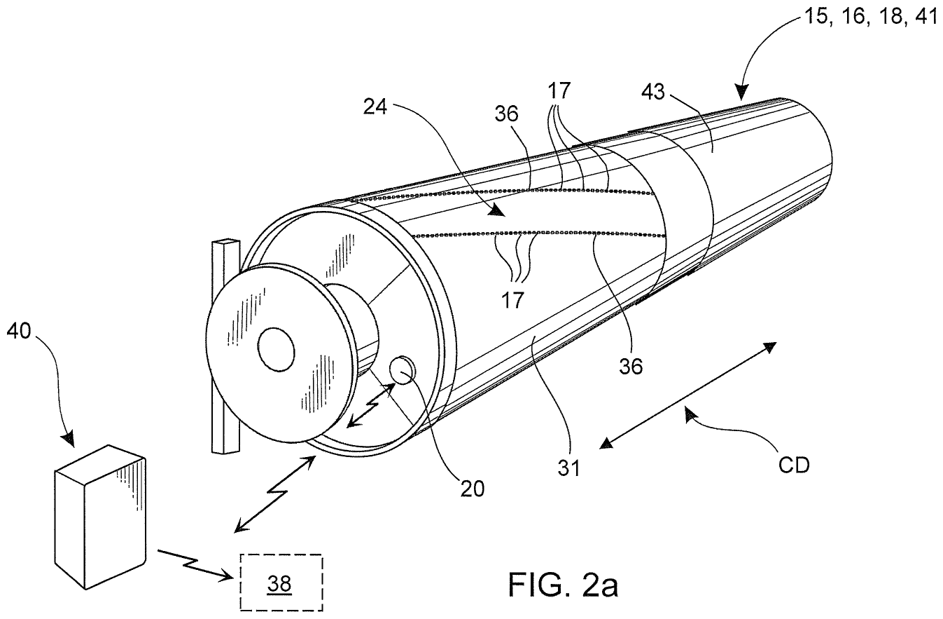

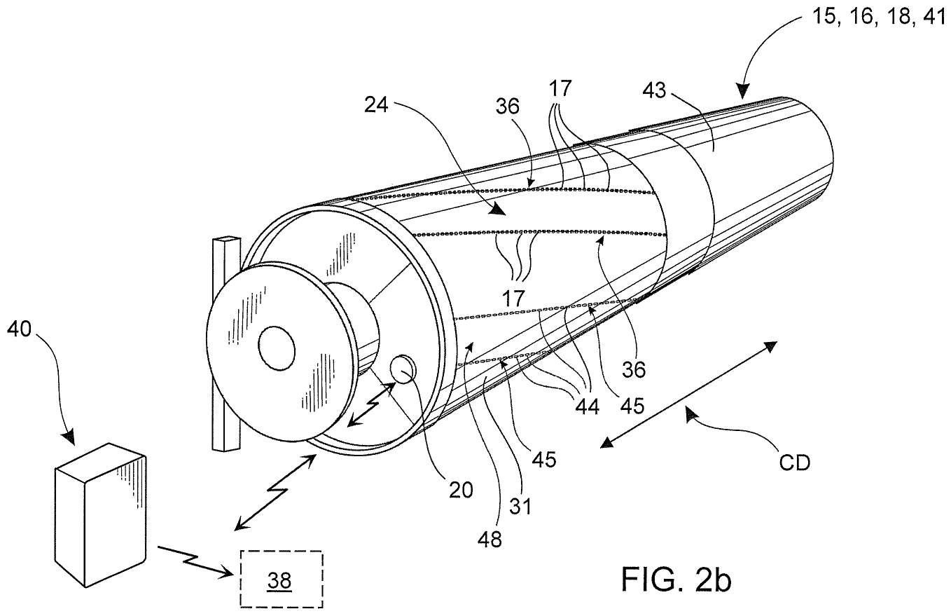

FIG. 2a shows an example of a machine element 41 that can be arranged to rotate. The machine element 41 can be, for example, one that forms a press nip 34, in other words it is provided with a nip roll 15, 16, a surface sizing roll 18 in the sizer 14 or, for example, a calender roll, or perhaps a reel-up drum of a reel, which is provided with, for example, a cooling water circulation, or a suction roll 8 equipped with a suction chamber 9, where the longitudinal and end seals that limit the suction chamber 9 are water-lubricated. More generally, the machine element can be a roll, the temperature of which is influenced, for example, in an adjustable manner by means of a medium, for example cooling and/or heating it. On the other hand, the temperature of the machine element 41 may also be affected by process factors, such as friction or pressure. The machine element 41 is equipped with a sensor assembly 24 that measures temperature. The sensor assembly 24 can be composed of any sensors 17 that measure temperature directly or indirectly. The sensor assembly 24 includes one or more temperature sensors 17. The temperature sensors 17 can be arranged, for example, onto the shell 31 of the machine element 41 and/or into a coating 43 arranged onto the shell 31, which coating 43 can be, for example, of rubber, polyurethane or epoxy with fiber reinforcement or without reinforcement. Some potential examples of the sensors 17 are temperature-sensitive semiconductors, resistive sensors or thermocouples. The sensor assembly 24 can be composed, for example, of a sensor band 36 or a series of sensors formed by one or more discrete sensors 17.

The temperature sensor band 36 can be on the roll, for example, spirally as shown in FIG. 2a or also in a straight row in the longitudinal direction of the roll. According to an embodiment, the sensor band 36 may even rotate around the roll in such a steep spiral that the sensor band 36 rotates around the roll several times. The configuration of the temperature sensor assembly 24 can hence be quite free. With a spiral installation, however, the installation of the temperature sensor band 36 is easy, and it has the least impact on the strength of the coating 43 of the roll. The sensor assembly typically extends over the length of the entire roll, but it is also possible to extend it more locally, for example only to the area of the end or ends of the roll. However, the installation geometry of the sensor band 36 in itself is not related to the operation of the sensor 17 or to the operation of the method to be presented below.

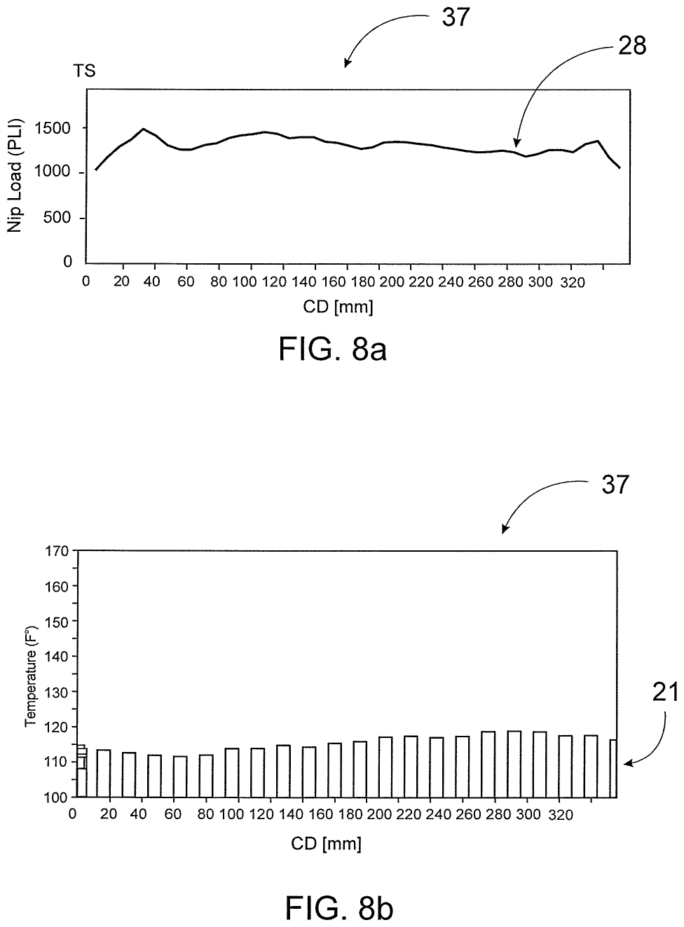

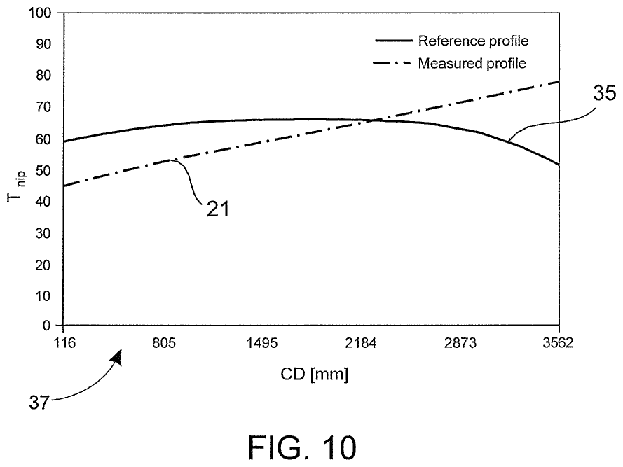

According to an embodiment, a separate conductor may be connected to each sensor 17 from the end of the roll, or the sensors 17 may also be connected in parallel. In the embodiment shown in FIG. 2a, the sensors 17 included in the sensor band 36 are advantageously connected in series. The sensors 17 can be intelligent in themselves. A pulse, which travels through the entire series of sensors, can be fed to the sensors 17 from the measurement electronics 40. As a result of this, each sensor 17 responds with its temperature or corresponding measurement signal 25 when it receives an excitation impulse from the measurement electronics 40. In this case, the first sensor (closest to the measurement electronics 40) of the sensor band 36 may respond first, followed individually by each sensor 17 after it until all sensors 17 have been covered. In this way, the measurement electronics 40 may receive a measurement signal 25, which corresponds to the temperature reading, from each sensor 17 as sampled data. The sampled data can be used as shown in FIGS. 8b, 9b, and 10 for generating the temperature profile 21 of the roll, which can be displayed on a display unit, or it can be used in the generation or computing of a reference profile 35, as shown in FIG. 10, generated for comparison to the temperature profile 21, such as in a comparison performed according to the method with respect to one or more reference profiles 35 generated for temperature. The embodiments related to the method are described in more detail in the description below.

Yet another way as compared to the pulse-connected/series-connected sensor band 36 described above is to use even more intelligent temperature sensors 17. In this case, each sensor 17 may have an address of its own, for example. In this case, the electronics 40 may always inquire the temperature from each sensor 17 so that the sensor, from which the temperature is inquired, is identified first with its address, then the sensor 17 responds to the inquiry for the information, and then the information is transmitted along a digital bus to the measurement electronics 40. In this configuration, the identifying address of each sensor 17 has thereby been defined for the electronics 40.

When the location of each sensor 17 on the roll is known (in its longitudinal direction, in other words in the cross direction of the machine), the longitudinal temperature profile 21 of the roll can be generated. A spiral installation also gives access to the temperature profile of the roll in the machine direction, in other words in the direction of the circumference.

A temperature profile measurement system installed onto the shell 31 of the roll 15, 16, 18 and/or under the roll coating 43, in other words onto the surface of the shell 31 and/or into the roll coating 43 and/or onto the roll coating 43 can be utilized in the invention. In the case of the applicant, it is marketed under the product name “iRoll Temp”. It is clear that corresponding sensor assemblies developed by other parties and related measurement systems for the measurement and generation of a temperature profile are also known. These are equally as well applicable to the implementation of the method and system according to the invention.

Temperature measurement and the generation of the temperature profile 21 on its basis can be carried out by measuring temperature for example at set time intervals, for example automatically. It is also to be noted that the roll does not even necessarily have to rotate, and still its temperature profile can be measured from the roll. It is therefore characteristic of the machine element 41 in connection with the method that the machine element 41 is rotatable.

The machine element 41 shown in the embodiment of FIG. 2b is equipped with a sensor assembly 24 that measures temperature and also with a sensor assembly 48 that measures force or pressure. The sensor assembly 48 can be composed of any sensors that measure pressure or force directly or indirectly. Some examples that can be mentioned here are piezoelectric sensors, piezoceramic sensors, piezoresistive sensors, force sensitive FSR sensors, capacitive sensors, inductive sensors, optical sensors, electromechanical film sensors, etc., which have a sufficient resolution for producing desired information. Again, the sensor assembly 48 can be composed of a sensor band 45 or a series of sensors formed by one or more discrete sensors 44.

According to an embodiment, the sensor assembly 48 that measures pressure or force can be based, for example, on an electromechanical film sensor 45 known per se. One or more film sensors 45 can be arranged onto the shell 31 and/or into the coating 43 of the roll. An example of such a film sensor 45 are sensors known with the trade name EMFi. Other sensors operating according to a corresponding principle and made of film-like materials may also be applied, such as PVDF sensors. More generally, these can be referred to as pressure sensitive film sensors. The sensor assembly 48 may typically be installed onto the surface of the shell 31 of the machine element 41. In this case, one or more surface layers, most typically a coating 43, are disposed on top of it. The sensor assembly 48 is protected under or inside the coating 43, or it can be installed between the coating layers. Completely similar installation principles may also be applied in the case of a temperature sensor assembly 36 arranged on a roll.

The sensors 45 that measure pressure or force can also be disposed on the shell 31 and/or in the coating 43 of the machine element 41 in a rising manner, as is shown in FIG. 2b. The sensor assembly 48 can be disposed on the shell 31 and/or in the coating 43 of the machine element 41 also in the circumferential direction. In this case, the sensors 45 can be disposed on the shell 31 of the roll at an even distance from each other. Therefore, no area free from sensors remains between them. When disposed in a rising manner, the sensors 45 rotate around the shell 31 of the machine element 41 in a spiral fashion at a distance from each other. The angle of rotation of the sensors 45, more generally the sensor assembly 48, on the shell 31 of the machine element 41 may be 180-320 degrees, for example. The machine element 41 may be provided with data transfer means 20 known per se for each sensor assembly 24, 48 for delivering a measurement signal 25, 50 generated by the sensor assembly 24, 48 to condition monitoring 38 included in the machine control automation. This can be implemented, for example, with a transmitter 20 provided at the roll end. With the transmitter 20, the measurement signal 25, 50 is delivered to a receiver 40 arranged outside the roll. The receiver 40 may also be provided with a delivery feature for delivering the measurement signal 25, 50 further to the machine control automation, to reception means 46 arranged therein. The receiver 40 may serve as a transmitter also towards the sensor assembly 24, as described above, when exciting the sensors 17, 44 for collecting a measurement signal 25, 50 from them.

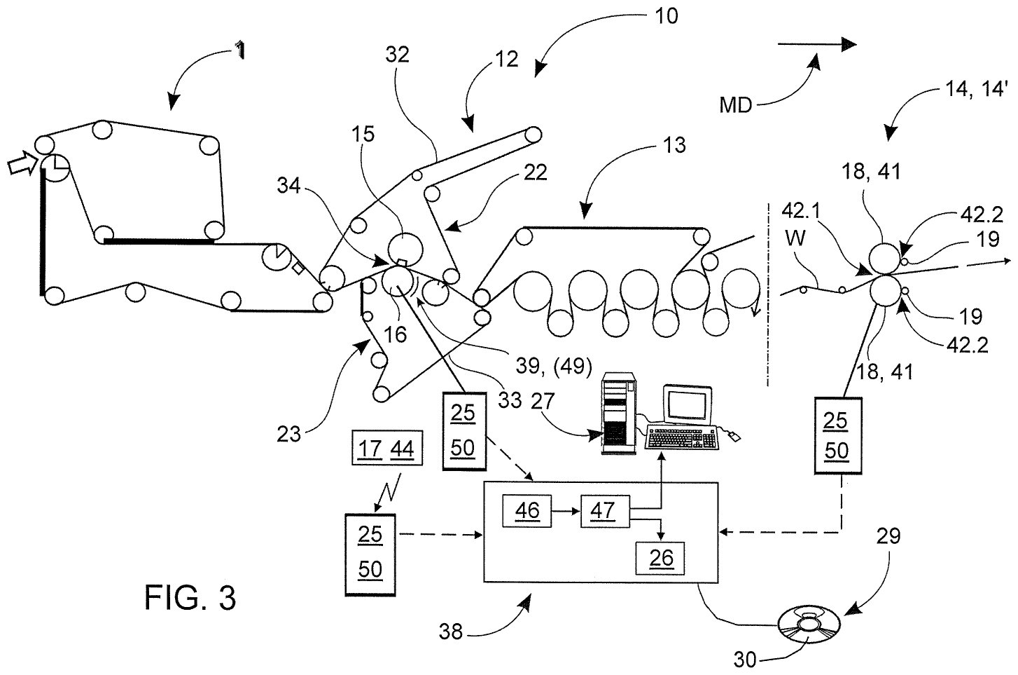

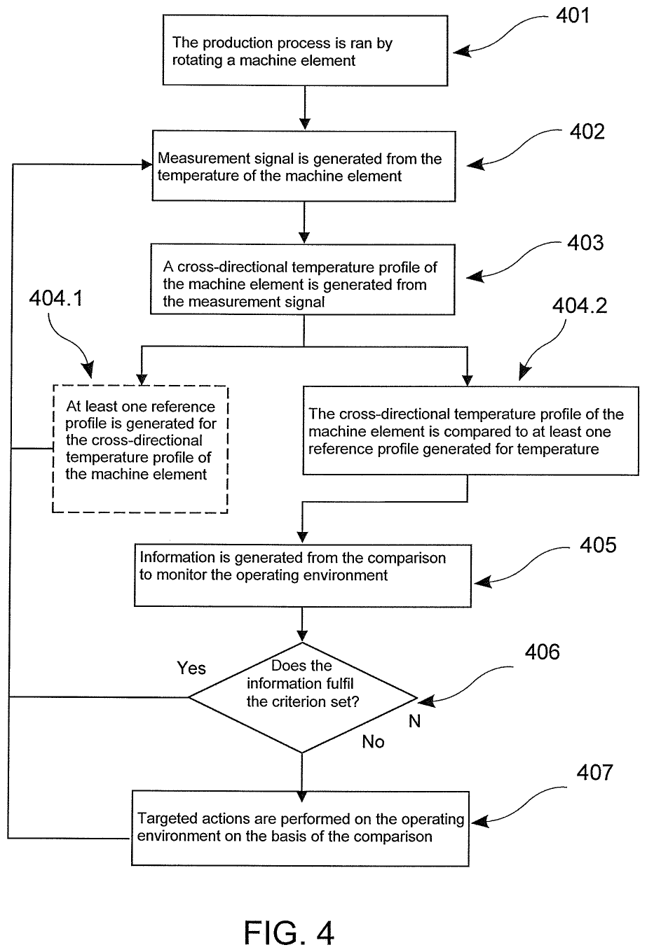

The method for the monitoring and control of the operating conditions of a fiber web machine or paper finishing machine is described below in more detail as an exemplifying embodiment referring to FIGS. 3 and 4. FIG. 3 shows the fiber web machine 10 of FIG. 1 and condition monitoring 38 connected thereto, and FIG. 4 shows a general flowchart of the method. The operating conditions of the machine are monitored by means of a machine element 41 that is included in the machine and that is rotatable in it. The shell 31 and/or coating 43 of the machine element 41 contains a sensor assembly 24 that measures temperature in the manner illustrated, for example, in FIG. 2a, or, as shown in FIG. 2b, a sensor assembly 48 that also measures force or pressure.

As step 401 of the method, the machine element 41 equipped with the sensor assembly 24 that measures temperature is rotated for example when performing a production run with the machine. As step 402 of the method, a measurement signal 25 is generated with the sensor assembly 24 arranged in the machine element 41 from the temperature of the machine element 41, to which temperature the measurement signal 25 generated with the sensor assembly 24 is proportionate. This temperature can vary in the cross direction (CD) of the machine, in other words in the longitudinal direction of the machine element 41. The measurement signal 25 generated with the sensor assembly 24 can be stored. As step 403, a cross-directional temperature profile 21 of the machine element 41 is generated from the measurement signal 25.

The cross-directional temperature profile 21 generated in step 403 can be utilized in step 404, which can comprise two sub-steps 404.1, 404.2. The steps 404.1 and 404.2 can be performed at least partially in parallel, if this is necessary. As step 404.1, one or more reference profiles 35 of temperature are generated for the cross-directional temperature profile 21 of the machine element 41 using the measurement signal 25. The generation of the reference profile 35 can take place, for example, as a one-off action or also in several separate periods mainly on a continuous basis. The reference profile can be generated when it is ascertained that the process and especially the devices included in it are operating as they are intended to in an optimal manner, and, for example, when the quality of the web W formed in the process corresponds to acceptable quality. More generally, the reference profile can be generated by collecting the measurement signal 25 over a single period of time or several such relatively long periods of time when the operating conditions of the fiber web or paper finishing machine 10, 14 and/or the quality of the product W formed are known to mainly fulfill the criteria set for these factors. This gives the cross-directional temperature profile in an optimal production situation. The reference profile 35 is generated, for example, by collecting the measurement signal 25 over a relatively long period of time known to be good in terms of production operation and quality, and by computing an average, for example, for it. In this case, the collection of the measurement signal 25 and the generation of the reference profile 35 may take place mainly on a continuous basis.

The generation of the reference profile 35 of temperature can also take place with pre-set periods of time. The reference profile 35 of temperature can be said to be characterized by a pre-set type of constancy and good properties when the production and also the quality are flawless. The aim is hence to generate a reference profile 35 when the operating conditions of the fiber web machine 10 and/or the operation of the relevant component are known to be mainly optimal and production is known to take place mainly without disturbances. The reference profile 35 of temperature of each machine element 41 is stored to be used by the machine control automation. The reference profile 35 is used to analyze a momentary cross-directional profile 21 generated in a position corresponding to the reference profile 35, which can be performed as step 404.2 in parallel with step 404.1.

Step 404.2 of the method comprises comparing the cross-directional temperature profile 21 of the machine element 41 generated from the measurement signal 25 and at least one reference profile 35 generated for it earlier in step 404.1.

The purpose of the comparison performed as step 404.2 is hence to find variation in the measured momentary cross-directional temperature profile 21 with respect to the reference profile 35 to find a change in the operating conditions of the fiber web or paper finishing machine 10. More precisely, this comparison can be the comparison of the momentary cross-directional temperature profile 21 and a disturbance-free reference profile 35 generated over a longer period of time to each other to detect, on the basis of a pre-set criterion, a variation, difference or corresponding change (deviation) in the cross-directional temperature profile 21 with respect to at least one reference profile 35. The variation, difference or change indicates a change in the operating environment or in how good it is. The change is usually also reflected in the quality of the product produced.

As step 405, information 37, particularly visual information, is generated from the comparison to monitor the operating environment. More specifically, visual information 37 can be generated from the comparison about the cross-directional temperature profile 21 with respect to a level of specified variation, difference or corresponding change/deviation and its location of occurrence in the cross direction (CD) of the machine.

If it is discovered in step 406 that variation, differences or change based on a set criterion occurred, it is possible to proceed to step 407 to perform actions on the basis of the change, related to the machine element 41 or to the condition of a peripheral device related to it and typically affecting via temperature, or related to how good the operation is. More generally, it can be said that the actions performed on the basis of the change are associated to changing the operating conditions of the fiber web or paper finishing machine 10, 14. On the other hand, the actions performed on the basis of the change may also be related to the design of the machine element 41 or its peripheral device.

Along with these actions, or if changes based on a set criterion were not discovered in step 406, the execution of the method is continued. The method can be executed as a parallel continuous loop at least regarding the comparison. The generation of the reference signal 35, in other words step 404.1, may be intermittent on the basis of a set criterion. It can take place, for example, on a recently-introduced machine element 41. On the other hand, it can also take place, for example, as a periodic specific calibration run. In this case, the reference profile 35 is generated as the state of the machine element 41 (or corresponding functional part being measured) changes as a result of, for example, aging or other factors of the process, but is still at an acceptable level.

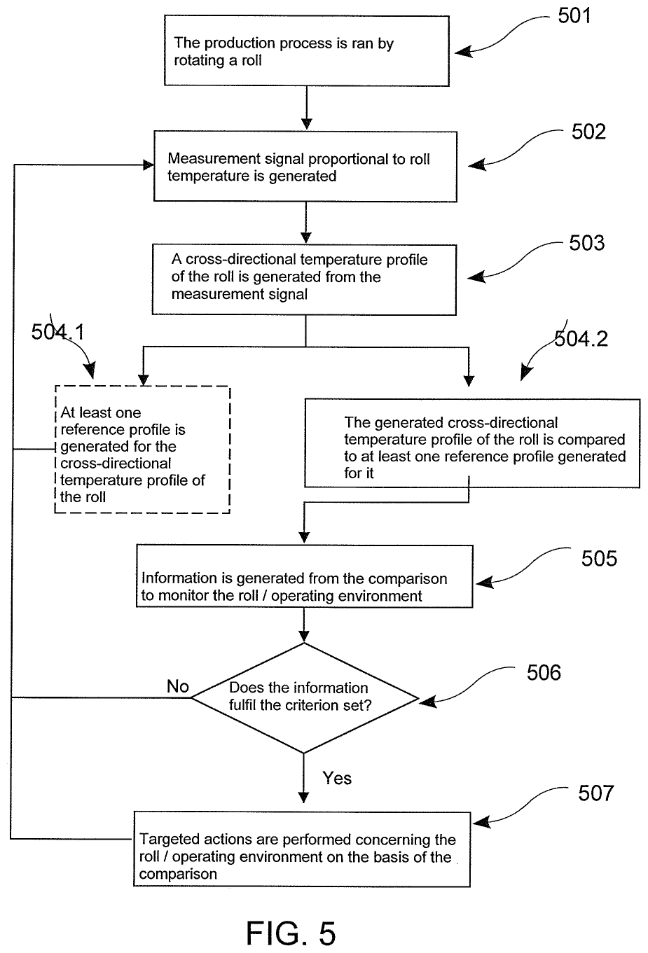

FIG. 5 shows an example of the method according to the invention as a flowchart, now for monitoring the condition and operation of the roll 15, 16, 18, and FIG. 10 shows information 37 generated from the profile measurement data 25 on a level of principle for monitoring the condition and operation of the roll 15, 16, 18 in two different situations. Now the rotating machine element 41 equipped with the sensor assembly 24 can be, for example, a nip roll 15, 16 included in a press nip 34, or also, for example, a roll equipped with a circulation of water or other medium and cooled (and/or heated) by it, such as a surface sizing roll 18 of a sizer 14′. A medium, such as water, is circulated inside the rolls 15, 16, 18 to cool or heat, for example, the surface sizing roll 18, or oil to load and/or lubricate for example the nip roll 15, 16. The roll may also be a roll equipped with cooling and/or heating, for example with lubrication showers and/or air blows or circulations. Correspondingly, an example in principle of the cross-directional temperature profile 21 of these rolls 15, 16, 18 is shown in FIG. 10. In this application of the method, the sub-steps are mainly corresponding to those shown earlier in FIG. 4. The main principle of the steps 501-504.1 and 504.2 can correspond to those described in connection with FIG. 4. In this step 504.1, too, a reference profile 35.1 is generated for the cross-directional temperature profile 21 of the roll 15, 16, 18.

In the embodiment shown in FIG. 5, the temperature profile sensor assembly 24 installed on a rotating nip roll 15, 16 and/or on a surface sizing roll 18 can be used for continuously monitoring the temperature of the roll 15, 16, 18 and its profile, collect and store data over a long period of time and examine changes as compared to the original reference of a clean roll, when lime and other impurities accumulate inside the roll as a result of the water circulation. Correspondingly, the temperature profile sensor assembly 24 installed on a rotating variable crown roll or zone-controlled roll 15, 16 can be used for continuously monitoring the temperature of the roll 15, 16 and its profile, collect and store data over a long period of time and examine changes as compared to the original reference of a roll 15, 16 that is in a good condition at the optimal operating point or to the values obtained from design.

In the comparison carried out as step 504.2, a difference profile of the temperature of the roll can be generated according to an embodiment. The difference profile is obtained when the stored reference profile 35 is deducted from the up-to-date temperature profile 21 measured continuously during production. In this case, the temperature profile measurement and comparison take place automatically. The computed difference profile can be used for establishing a bar diagram, for example, of temperature.

In step 505, the information 37 generated can be an up-to-date cross-directional temperature profile 21 during production, and in addition to this, it is possible to generate the above-mentioned computed difference profile, where the mainly real-time temperature profile 21 has been deducted from the reference profile. These can be displayed in the control room as, for example, profile displays and as a color scheme on the operator screens. These show easily how the cross-directional temperature profile 21 has changed. As an example, a warning can be given on the basis of the difference profile when the values are starting to approach the alarm limits set. When a limit is exceeded, an alarm is generated. Some other distortion and/or development, too, such as one based on a set criterion, in the cross-directional temperature profile may trigger an alarm.

The development of the temperature profile can also be compared to corresponding measurements carried out and stored during earlier steps in production. The comparison can be performed manually or automatically. Based on the comparison, alarms can be generated when the temperature profile approaches values based on, for example, empirical information, which indicate a problem in a roll. In this case, it is possible to learn to generate an alarm even automatically more precisely when the values are starting to approach values that indicate issues such as failure or fouling of a roll. In this case, it is possible to plan the correct timing of the maintenance or replacement of the roll in a controlled manner.

The above-mentioned issues are analyzed as step 506 either automatically by condition monitoring, or by the operator. If a set criterion is fulfilled, as step 507 it is possible to perform reconditioning actions concerning the roll, or the roll can be replaced with another one if the control actions in its operating parameters do not yet give the desired outcome, in other words a desired profile change.

More specifically, in a first embodiment, in other words in the case of a roll 18 located on the sizer 14′ and equipped with cooling water circulation, the method and system can be used to monitor and optimize the operation of the internal cooling water circulation of the roll 18. If the accumulation of lime has a very great impact on the temperature profile 21 of the roll 18, it is possible to take the roll 18 out of the machine 14′ for cleaning after a change in accordance with a set criterion has been discovered in the cross-directional temperature profile 21 of the roll 18. In a lesser case, it is possible to change the temperature and flow of water circulated in the roll 18 so that the desired minimum cooling is accomplished in every area of the roll 18.

In a second embodiment, in turn, the method and system can be used in a roll equipped with oil circulation, such as in a roll 15, 16 that forms a press nip 34, to monitor and optimize the internal oil circulation and components of the roll 15, 16. If, due to a factor such as a poor oil film, the temperature of the roll 15, 16 starts to rise, the roll 15, 16 can be taken out for service. Or, if the oil circulation of the roll 15, 16 is not optimal, its impact can be monitored in various situations, and the information can be used to improve the operation of the roll 15, 16 in component updates, for example, and/or, for example, the flow can be adjusted and/or cooling can be increased. The method can hence be used to find changes in the operating condition of the rolls 15, 16, 18.

It is also possible to monitor and adjust the temperature of the roll 18 more locally by means of a sensor assembly installed, for example, in the end area only. A general problem with rolls such as rolls coated with polyurethane or rubber, for example suction rolls, is that water becomes diffused between the coating and the roll body, especially in those areas of the ends of the roll that are outside the web width. The reason for this is the colder temperature of the inner parts of the end, when the seals that restrict the suction chamber of the suction roll are lubricated with abundant cold water, together with the cooling of the roll taking place via the shaft. In this case, the temperature gradient intensifies the diffusion greatly, and in the worst cases the polyurethane surface becomes loose from the roll body after just a few weeks' run. A temperature sensor assembly that can be placed in the manner presented earlier over the entire length of the roll or only in the end areas or at the end of the roll either under the coating or even inside the roll can be used to measure temperature, and on the basis of the measurement it is possible to adjust the amount or temperature of the lubrication water so that no temperature gradient arises and that no diffusion takes place. It is hence possible to extend the life time of the coating by means of our invention.

Moreover, as step 506 it is also possible to compare the difference between consecutive temperature profiles 21, i.e. one after the other, as a function of time. If any (local) change is detected in these, issues such as sudden roll coating failure can be identified and/or predicted from it. The system can learn to identify sudden failures, for example by examining the difference between consecutive measurements of the temperature profile: too high a difference indicates a failed location in the roll coating.

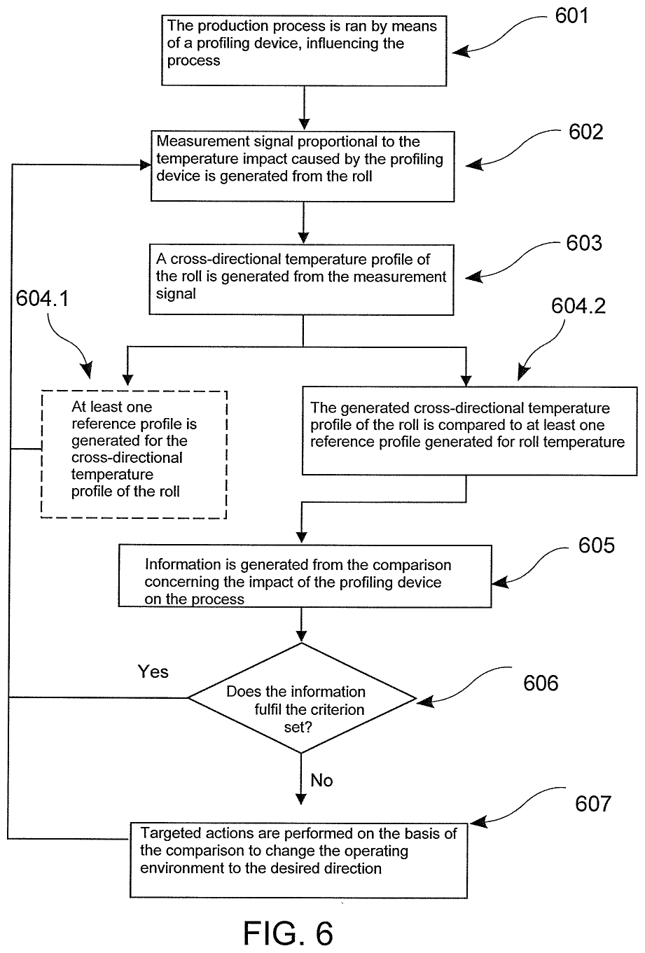

FIG. 6 shows a flowchart view of an example of the method according to the invention for the monitoring and control of the condition and operation of a profiling device 39. Here, too, the rotating machine element 41 equipped with a sensor assembly 24 can be, for example, a nip roll 16 included in a press nip 34. In this application of the method, too, the initial sub-steps are mainly corresponding to those shown earlier in FIG. 4. The main principle of the steps 601-604.1 and 604.2 can correspond to those described in connection with FIGS. 4 and 5.

However, the difference in this embodiment to the earlier one is that now the temperature profile sensor assembly 24 installed on a rotating press roll or other roll 16 is used for continuously monitoring the temperature of the roll 16, its profile, and the impact that is exerted on these from external profiling devices 39, such as an induction profiling device, air profiling device, infrared profiling device and especially a steam box 49 in the press section. As step 604.1, a reference profile 35.1 is generated for the cross-directional temperature profile 21 of the roll 16, which profile consequently also includes impact of the profiling device 39. Data are again collected and stored over a long period of time in the generation of the reference profile 35.1. The reference profile 35.1 can represent a situation where the profiling device 39 is closed, in other words out of use, or a situation that has been found to be optimal.

As step 604.2, the mainly real-time temperature profile of the roll 16 is compared to the reference profile, and as step 605, the changes occurring in the temperature profile are examined. If it is ascertained in step 606 that the change or the information generated from it does not fulfill the criterion set, the next step is step 607, where targeted actions based on the comparison are performed to change the operating environment to the desired direction. In this embodiment, the method and system can be used, for example, to optimize the operation of the profiling device 39 and the profile of the roll nip 34 and to monitor disturbances of the profiling device 39.

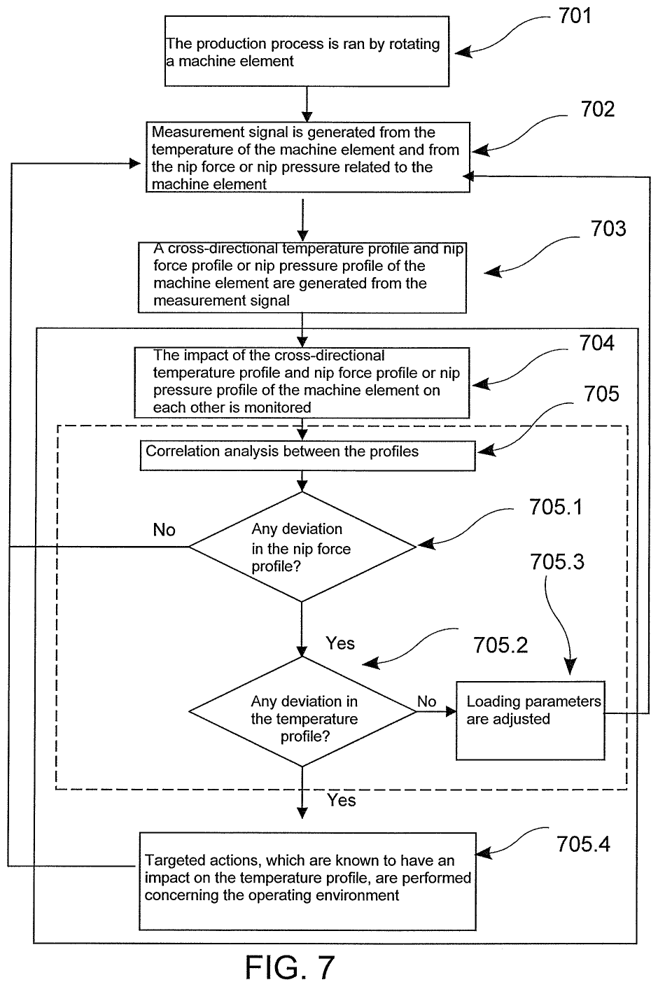

FIG. 7 shows a flowchart view of yet a third example of the method according to the invention to monitor and also control the operating conditions of the production process, which utilizes the above-mentioned temperature measurement and now also the measurement of the nip force or pressure related to the nip 34, 42.1, 42.2 formed by the machine element 41 and the generation of the profile from it together. As far as the temperature measurement is concerned, the steps 701-703 of the flowchart can correspond to the steps presented earlier in the embodiments above. In this embodiment, the corresponding steps are also performed as far as the measurement of the nip force and the generation of the profile from it are concerned, in other words, in connection with the rotation of the machine element 41 the machine element 41 is measured, and the nip force profile or pressure profile 28 is generated.

As step 704, the impact of the measurement of the nip force profile and temperature profile on each other is monitored. As step 705, a correlation analysis, for example, is performed of the profiles 21, 28. This is used for examining whether the profiles 21, 28 exhibit a deviation in accordance with the criterion set. In this case, in a potential deviation situation occurring in the force profile or pressure profile 28 and/or in the cross-directional temperature profile 21, the measured force profile or pressure profile 28 and the cross-directional temperature profile 21 of the machine element 41 are analyzed to find a potential correlation between them. As an example, if the measurement of the nip profile sees in step 705.1 that there is a high load somewhere in the nip profile 28, it can be checked in step 705.2 whether this is also seen in the temperature profile. If it is not seen, there is some problem in the loading of a water-circulated roll 18, but the water circulation of the roll 18 works as intended. More generally, what is therefore defined here is, on the basis of discovering a correlation, a factor that causes the deviation situation occurring in the nip force profile or pressure profile 28 and/or in the cross-directional temperature profile 21. Moreover, on the basis of discovering a correlation, actions targeted at the factor that causes the deviation situation are also performed to compensate for the deviation occurring in the force profile or pressure profile 28 and/or in the cross-directional temperature profile 21 of the machine element 41.

A second embodiment opportunity is also the monitoring and control of surface sizing carried out by means of a paper finishing machine 14, more specifically by means of a sizer 14′. In this embodiment, the rotatable machine element 41 equipped with sensors is a roll 18 of a surface sizing device 14′, via which the paper web W travels through a nip 42.1 formed by the machine element 41 and another roll. A rod 19 is used for spreading the sizing agent onto the surface of the roll 19 in a manner known per se. Switching on the water circulation on the sizer 14′ and/or the heat brought by the web W may affect the loading profile of the surface sizing nip 42.1 or of the rod 19 nip 4.2, which profile is now a force profile or pressure profile 28. In this case, too, it is again possible to distinguish which portion of the profile changes comes from the heat and which portion comes from other devices or parameters, and it is possible to perform actions—adjustment of loadings as step 705.3 and/or adjustment of water circulation as step 705.4—to compensate for these changes, more generally a deviation occurring in the force profile or pressure profile 28 and/or in the cross-directional temperature profile 21.

Correspondingly, for example with variable crown rolls or other corresponding rolls 15, 16 equipped with oil circulation, it is also possible to follow the impact of the measurement of the nip force profile and temperature profile on each other. In this case, for example, if the measurement of the nip profile sees in step 705.1 that there is a high load somewhere in the nip profile 28, it can be checked in step 705.2 whether this is seen in the temperature profile 21 of the roll 15, 16. If it is not seen, there is probably some problem (step 705.3) in the loading parameters, but the internal parts of the roll 15, 16 work correctly. In this case, step 705.4 can be omitted, and it possible to return directly to step 702.

Furthermore, the same follow-up can also be applied to the profiling devices 39. The correlation of the measurement of the nip force profile and temperature profile with each other can be followed in them, too, as step 705. If the measurement of the nip profile sees in step 705.1 that there is a high load somewhere, it can be checked in step 705.2 whether this is also seen in the temperature of the roll 15, 16. If it is not seen, there is probably some problem in the loading parameters, and it is possible to proceed to step 705.3. If, however, the phenomenon is also seen in the temperature, the reason is probably due to the impact of the profiling actuator 39, which can be subsequently improved in step 705.4. Failures of the profiling actuator 39 can also be identified from errors in the temperature profile. An example related to this is presented below.

FIG. 8a shows an example of a nip force profile 28 measured from a roll by the sensor means 48, and FIG. 8b shows a temperature profile 21 measured by the sensor means 24 arranged in the roll 16. The measurement has been carried out while the steam box 49 in the press section 12 was out of use. It can be seen in the nip force profile of FIG. 8a that the load profile 28 is fairly symmetrical.

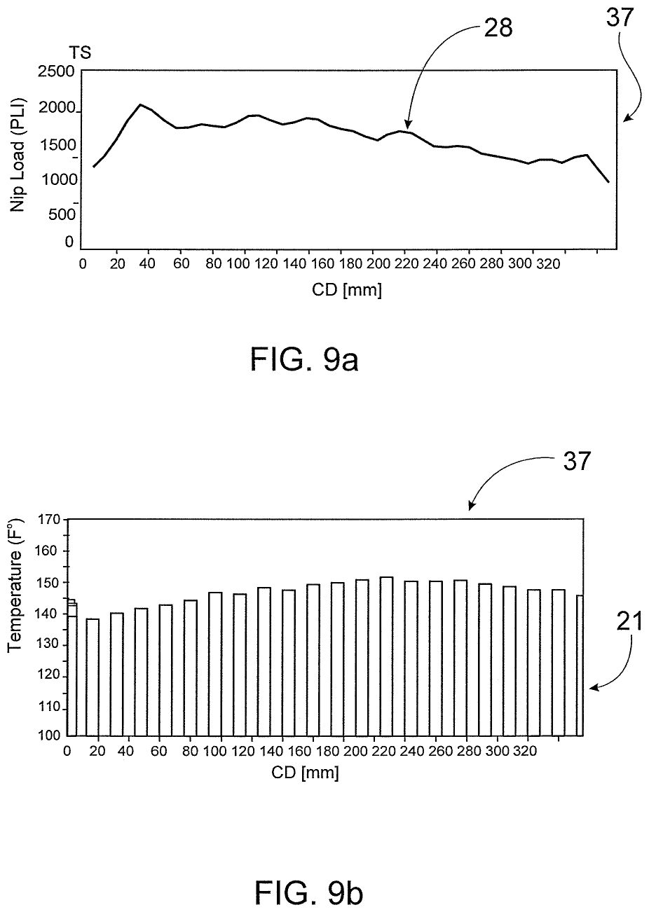

FIG. 9a shows an example of a nip force profile 28 measured from a roll by the sensor means 48, and FIG. 9b shows a temperature profile measured by the sensor means 24 arranged in the roll 16; these were measured from a corresponding roll as in the measurement shown in FIGS. 8a and 8b. Now the measurement has been carried out while the steam box 49 in the press section 12 was in use. It can be seen that the temperature is now higher, and it also has a bigger shape in the profile 21. The load profile 28 is also inclined now. The profile 28 has become inclined due to the impact of the inclined profiling of the steam box 49. The problem may also cause roll surface damage.

FIG. 10, in turn, shows a graph of the cross-directional temperature profile 21 from the applications shown in FIGS. 4-6. A person having ordinary skill in the art understands that in reality the shapes of the profiles can vary greatly from these. There is a location axis in the horizontal direction, in other words locations on the shell 31 of the machine element 41 in the cross direction CD of the machine, and a temperature axis in the vertical direction. The solid line in FIG. 10 illustrates the reference profile 35 of temperature. It illustrates the cross-directional temperature profile in a situation where the operating conditions and the quality of the web W are as desired. The reference profile 35 may have been generated over a longer period of time, when the operation of the machine has been at an optimal level.

The cross-directional profile 21 illustrated with the broken line in FIG. 10 shows the mainly real-time temperature profile measured on the machine element 41.

The difference to the reference profile 35 generated can be seen clearly in this mainly real-time measured cross-directional profile 21. The comparison of the measured cross-directional profile 21 to the reference profile 35 can be performed online mainly automatically. In this case, it can be seen from the measurement signal 25 whether the measured profile changes, and if it does, what type of a change it is.

The finding of variations, differences and changes, generally the finding of deviations, more generally comparison, and the finding of correlations can be performed from the profiles 21, 28 mainly on a continuous basis. The information 37 may also be more refined than just profiles. It can be, for example, various kinds of indices, trends and spreadsheets. The information 37 can be published on the screen 27 of the automation system 38 position-specifically, for example at prescribed time intervals or at time intervals specified by the user.

In addition to the method, the invention also concerns a system for the monitoring and control of the operating conditions of a fiber web or paper finishing machine, which system is arranged to be carried out on a rotatable machine element 41. The machine element 41 is equipped with a sensor assembly 24 that measures temperature. The system includes a sensor assembly 24 that measures temperature, arranged on the shell 31 and/or in the coating 43 of one or more machine elements 41 to generate a measurement signal 25 of the temperature of the machine element 41. Moreover, the system also includes processing circuit 47 for example a general purpose computer or processor e.g., on an integrated semiconductor chip, arranged to generate a cross-directional temperature profile 21 of the machine element 41 from the measurement signal 25, user interface means 27 to review said cross-directional profile 21 or the information derived from it/related to it, and memory means 26.

In the system, one or more reference profiles 35 are arranged to be generated by the processing means 47 from the measurement signal 25 generated by the sensor assembly 24 for the cross-directional temperature profile 21 of the machine element 41. The reference profile 35 is arranged to be stored in the memory means 26 such as a digital memory such as a magnetic or optical disk or solid state storage. The processing means 47 are arranged to compare the cross-directional temperature profile 21 of the machine element 41 generated from the measurement signal 25 and at least one reference profile 35 generated for it to find a change concerning the operating conditions of the fiber web or paper finishing machine 10, 14. The user interface means 27 are arranged to generate information 37 concerning the operating conditions of the fiber web or paper finishing machine 10 from the comparison to perform actions on the basis of the change. The purpose of the comparison is to find variation, differences and changes in the profiles. On a more general level, these can also be referred to as deviations. The system is arranged to perform the sub-steps of the above-described method by means of computer, for example.

According to an embodiment of the system, the machine element 41 can also be equipped with a sensor assembly 48 that measures force or pressure, which sensor assembly 48 is arranged to measure, in addition to the temperature profile, the force profile or pressure profile 28 related to the nip 34, 42 formed by the machine element 41. In this case, the processing means 47 are arranged to also analyze the measured force profile or pressure profile 28 and the cross-directional temperature profile 21 of the machine element 41 to find a potential correlation between them advantageously in a potential deviation situation occurring in the force profile or pressure profile 28 and/or in the cross-directional temperature profile 21. The user interface means 27 are arranged to present results related to the correlation analysis and advantageously to suggest targeted actions on the basis of finding or not finding a correlation to compensate for the deviation occurring in the force profile or pressure profile 28 and/or in the cross-directional temperature profile 21 of the machine element 41.

In addition to the method and system, the invention also concerns a rotating machine element 41. It includes a shell 31, a coating 43 arranged over the shell 31 and a sensor assembly 24 installed, for example, in a spiral manner under or inside the coating 43. The machine element 41 is used in the above-described method or system to monitor and control the operating conditions with regard to and concerning temperature.

The rotating machine element 41 in the system can be, for example, a nip roll 15, 16 that forms a press nip 34, a roll 18 with water circulation and/or a roll 16 influenced by a profiling device 39.

In addition to the method and system, the invention also concerns a computer program product 29. The computer program product 29, which may be downloadable, for example, by means of a suitable storage medium or over a data network, contains a computer program logic 30 configured to accomplish the various applications of the above-described method to monitor and control the operating conditions with regard to and concerning temperature.

The methods, systems and computer program logics 30 according to the invention can be arranged, for example, as part of the machine control automation. The control can be automatic and mainly continuous. An additional advantage is that the systems are automatic, up to date and learning.

It is to be understood that the above description and the related figures are only intended to illustrate the present invention. The invention is hence not only restricted to the above-presented embodiments or to the embodiments defined in the claims, but several different variations and adaptations of the invention will also be obvious to a person having ordinary skill in the art, which variations and adaptations are possible within the inventive idea defined by the enclosed claims.

We claim:

1. A method for monitoring and controlling operating conditions of a rotatable machine element in a fiber web machine or paper finishing machine, which rotatable machine element is equipped with a sensor assembly that measures temperature, comprising the steps of:
generating a cross-directional temperature profile which changes with time, by measurement of a temperature signal corresponding to temperature of the machine element from at least one temperature sensor in the sensor assembly;
generating at least one cross-directional reference temperature profile of the machine element which is not changing with time;
comparing the cross-directional temperature profile which changes with time to the at least one cross-directional reference temperature profile of the machine element to detect changes in operating conditions of the fiber web machine or paper finishing machine;
performing at least one control action based on said changes in operating conditions of the fiber web machine or paper finishing machine.

2. The method of claim 1 wherein the at least one temperature sensor forming part of the sensor assembly is arranged on a roll shell of the machine element or in a coating arranged on the roll shell.

3. The method of claim 1 wherein the step of generating the at least one cross-directional reference temperature profile is performed by collecting the measurement signal over a single period of time or several periods of time when the operating conditions of the fiber web machine or paper finishing machine substantially meet selected criteria.

4. The method of claim 1 wherein the step of generating the at least one cross-directional reference temperature profile is performed by collecting the measurement signal over a single period of time or several periods of time, when the attributes of a product being produced on the fiber web machine or paper finishing machine substantially meet selected criteria.

5. The method of claim 1 wherein the step of performing at least one control action is related to changing the operating conditions of the fiber web machine or paper finishing machine.

6. The method of claim 1 further comprising the steps of:
generating at least one cross-directional force profile or pressure profile of a nip formed by the machine element which changes with time, by measurement of a force or pressure signal corresponding to force or pressure profile of the machine element from at least one force or pressure sensor in the sensor assembly;
analyzing the at least one cross-directional force profile or pressure profile which changes with time with the cross-directional temperature profile which changes with time and determining whether there is a correlation over time between the cross-directional force profile or pressure profile and the cross-directional temperature profile which changes with time;
performing the at least one control action based on whether there is a correlation or there is not a correlation.

7. The method of claim 1 wherein the rotating machine element is a roll having an interior containing a medium, wherein the medium is circulated to control the temperature of the roll and wherein the step of performing at least one control action includes changing the temperature of the medium based on said changes in operating conditions of the fiber web machine or finishing machine.

8. The method of claim 6 wherein the rotating machine element is a roll having an interior containing a medium, the medium is circulated to control nip load of the roll and wherein the step of performing at least one control action is to change the temperature or pressure of the medium based on said changes in operating conditions of the fiber web or paper machine or finishing machine.

9. The method of claim 1 wherein the rotating machine element is a roll having at least one profiling element for changing the temperature of the roll and wherein the step of performing at least one control action comprises changing an output of the at least one profiling element.

10. The method of claim 1 wherein the rotating machine element is a roll having an interior containing a medium which is circulated to control the temperature of the roll, and wherein the step of performing at least one control action comprises changing the flow of the medium circulated in the roll based on said changes in operating conditions of the fiber web machine or finishing machine.

11. The method of claim 1 wherein the rotating machine element is a roll having an interior containing a flow medium which is circulated to control the temperature of the roll and wherein the step of performing at least one control action comprises cleaning flow passages in the roll for the flow medium.

12. The method of claim 6 wherein the fiber web machine or finishing machine is a surface sizing device, and wherein the at least one cross-directional force profile or pressure profile of a nip is at least one of a loading profile of a surface sizing nip between a sizing roll forming the machine element and a counter sizing roll; and a loading profile of a rod and at least one of the sizing roll and the counter sizing roll, and wherein said at least one control action performed comprises adjusting the loadings or adjusting a circulation of a supply of a medium, to compensate for a deviation occurring in the force profile or pressure profile or in the cross-directional temperature profile.

13. The method of claim 1 further comprising the step of: generating visual information comparing the cross-directional temperature profile which changes with time with the cross-directional reference temperature profile.

14. The method of claim 1 wherein the at least one control action performed based on said changes in operating conditions comprises modifying the machine element design.

15. A system for the monitoring and control of at least one operating condition of a fiber web machine or paper finishing machine, which system is arranged to be carried out on a rotatable machine element which is equipped with a sensor assembly that measures temperature, the system comprising:
a sensor assembly for measuring temperature and generating a measurement signal, arranged on at least one of a shell and a coating on the shell of the machine element and arranged to generate a measurement signal from the temperature of the machine element;
a circuit arranged to generate a cross-directional temperature profile of the machine element from the measurement signal which changes with time;
a computer terminal arranged to examine said cross-directional profile;
a digital storage memory;
wherein the circuit is arranged to generate one or more reference profiles from the measurement signal generated by the sensor assembly, which one or more reference profiles do not change with time and are arranged to be stored in the digital storage memory;
wherein the circuit is arranged to compare the cross-directional temperature profile which changes with time and at least one of one or more reference profiles to show change concerning the at least one operating condition of the fiber web machine or paper finishing machine; and
wherein the computer terminal is arranged to generate information concerning change in the at least one operating condition of the fiber web machine or paper finishing machine from the circuit arranged to compare the cross-directional temperature profile which changes with time and at least one reference profile and wherein the computer terminal is arranged to perform actions, based on said change, on the fiber web machine or paper finishing machine.

16. The system of claim 15 wherein the machine element is equipped with a force or pressure sensor assembly that measures force or pressure, which sensor assembly is arranged to measure a force profile or a pressure profile related to a nip formed by the machine element, and the circuit is arranged to perform a correlation analysis of the measured force profile or pressure profile and the cross-directional temperature profile of the machine element to find a correlation between them;
wherein the computer terminal is arranged to present results related to the correlation analysis and to suggest targeted actions on the basis of finding or not finding a correlation, to compensate for deviation occurring in the force profile or pressure profile or in the cross-directional temperature profile of the machine element.

17. The system of claim 16 wherein the rotatable machine element is a roll equipped with fluid circulation or a profiling device.

18. A method for monitoring and controlling operating conditions of a rotatable machine roll in a fiber web machine or paper finishing machine, comprising:
continuously measuring a cross machine direction temperature profile of a rotatable machine roll and displaying the cross machine direction temperature profile and comparing it with a selected reference cross machine direction temperature profile of the rotatable machine roll, wherein the selected reference cross machine direction temperature profile corresponds to an average or nominal or calculated value of the cross direction temperature profile of the rotatable machine roll; and
using the comparison as an input to a display for manual control or to an automatic control system or program for machine control.

19. The method of claim 18 further comprising continuously measuring a cross machine direction pressure profile of a nip formed by the machine element and displaying the cross machine direction pressure profile of the nip for manual control or as input to the automatic control system or the program for machine control.

20. The method of claim 18 further comprising the step of, if the cross machine direction temperature profile and the selected reference cross machine direction temperature profile meet a selected criterion set, adjusting a function of the rotatable machine roll selected from: adjusting a profile device for the machine roll, a fluid flow or fluid temperature in the roll, or a fluid pressure, or cleaning fluid channels in the roll.
